(19) United States
(12) Patent Application Publication
(10) Pub. No.: US 2012/0008922 A1
(43) Pub. Date: Jan. 12, 2012

(54) IMAGE QUALITY CONTROLLING CONTENTS GENERATION DEVICE, IMAGE QUALITY CONTROL DEVICE, COPY IMAGE QUALITY CONTROL SYSTEM, COPY IMAGE QUALITY CONTROL METHOD, IMAGE QUALITY CONTROLLING CONTENTS GENERATION PROGRAM AND IMAGE QUALITY CONTROL PROGRAM

(75) Inventor: Kozo Satoda, Tokyo (JP)

(73) Assignee: NEC Corporation, Minato-ku, TOKYO (JP)

(21) Appl. No.: 13/257,794

(22) PCT Filed: Mar. 15, 2010
(86) PCT No.: PCT/JP2010/054315

§ 371 Date: Sep. 20, 2011

(30) Foreign Application Priority Data
Mar. 26, 2009 (JP) 2009-075688

(51) Int. Cl. H04N 9/80

(52) U.S. Cl. 386/253; 386/E05.003

(57) ABSTRACT

An image quality controlling contents generation device which generates image quality controlling contents from video contents, includes a scalable coding unit which hierarchically codes said video contents to generate image quality controlling video contents, and a scalable coding parameter generation unit which generates a coding parameter for controlling a hierarchical structure for use in executing scalable coding at said scalable coding unit.

### TECHNICAL FIELD

The present invention relates to an image quality controlling contents generation device, an image quality control device, a copy image quality control system, a copy image quality control method, an image quality controlling contents generation program and an image quality control program, and more particularly, a technique for controlling quality of video contents as of after copying by deteriorating quality of video contents at the time of copying.

### BACKGROUND ART

As video contents copying prevention measures, in a case of analog video, the macro-vision method and the like have been put into practical use and when contents whose copying is guarded by this method are copied, copied video is disturbed to result in preventing copying. While this method is used in video contents or the like on the market, broadcasting video contents commonly on air are provided with none of a copying prevention function because analog video contents have their quality deteriorated by coping.

On the other hand, in a case of video contents to be digitally distributed, digitally copying the contents will have no deterioration, so that copy of the same quality as that of an original will be inappropriately distributed. In a case of digital video, therefore, digital broadcasting also adopts a method of limiting the number of times of copying such as copy once or copy ten. While copying prevention measures enable the number of times of copying to be limited such as copy once or copy ten, since no video quality will be deteriorated at each copying, there remains a possibility that video contents whose image quality is the same as that of an original will be inappropriately distributed. Under these circumstances, a lot of techniques have been proposed to avoid distribution of copied contents having the same quality as that of an original by deteriorating image quality of each copy.

Recited, for example, in Patent Literature 1 is a method of making a part of video be unseen by reducing the number of encryption keys on a copy basis. Related art disclosed in Patent Literature 1 is to make video contents be unseen on a copy basis to prevent viewing and listening with the same quality as that of an original, for example, by reducing, with video contents divided according to places such as a screen upper part, the center and a screen lower part and with the respective parts enciphered by separate encryption keys, the number of encryption keys for each copy to make the screen upper part be unseen and then the screen lower part be unseen.

Proposed in Patent Literature 2 is related art for preventing copying with high quality for the promotion of video contents. Although when all the contents are distributed with high image quality, high image quality video will be flown out at the time of copying, using low image quality contents for promotion will have little effect. Therefore, it is designed to prevent simple copying from making flow-out of high image quality video by generating image contents such that for initial few seconds (few minutes), high image quality video will be reproduced and then low image quality video will be reproduced.

Proposed in Patent Literature 3 is related art of controlling quality of an image to be decoded in image encryption according to whether a decoder has a decoding key or not, or when a plurality of encryption levels are provided, according to whether the decoder has encryption keys of the encryption levels.

Patent Literature 1: Japanese Patent Laying-Open No. 2007-124167

Patent Literature 2: Japanese Patent Laying-Open No. 2006-229661

Patent Literature 3: WO2002-54602.

According to the related art disclosed in Patent Literature 1, although contents are deteriorated at each copying, because all the contents are copied at the time of copying, they might be decoded by a malicious user. In addition, making a part of video be unseen prevents check of copied contents as a whole. According to the related art disclosed in Patent literature 2, which is not the method of making a part of video be unseen, while it is possible to check video as a whole, it is impossible to execute control to deteriorate a part of video at the time of copying.

According to the related art disclosed in Patent Literature 3, it is possible to control quality enabling SVC reproduction (Scalable Video Coding) by combining a plurality of encryption levels with hierarchical coding levels such as SVC. However, since all the enciphered contents of an original are transmitted to a receiver, the receiver side will have contents of all the layers, so that when a malicious user obtains a high quality encryption key falsely, high quality contents reproduction will be possible.

### OBJECT OF THE INVENTION

An object of the present invention is to provide an image quality controlling contents generation device, an image quality control device, a copy image quality control system, a copy image quality control method, an image quality controlling contents generation program and an image quality control program which prevent reproduction of contents with higher image quality than intended by a contents designer by setting up a mechanism which realizes control of reproduction quality by transmitting only contents of a necessary layer.

### SUMMARY

According to a first exemplary aspect of the invention, an image quality controlling contents generation device which generates image quality controlling contents from video contents, includes

a scalable coding unit which hierarchically codes the video contents to generate image quality controlling video contents, and

a scalable coding parameter generation unit which generates a coding parameter for controlling a hierarchical structure for use in executing scalable coding at the scalable coding unit.

According to a second exemplary aspect of the invention, a copy image quality control system, includes

an image quality controlling contents generation device which generates image quality controlling video contents which control image quality from video contents,

a video distribution device which distributes the image quality controlling video contents in response to a request, and

an image quality control device connected to the video distribution device through a network to receive the image quality controlling video contents from the video distribution device and control image quality according to a mode of use.

According to a third exemplary aspect of the invention, a copy image quality control method for use in a copy image quality control system to which connected through a network are a video distribution device which distributes image quality controlling video contents generated by an image quality controlling video contents generation device in response to a request and an image quality control device to which a contents reproduction device is connected, includes

a first step of the image quality controlling contents generation device to generate image quality controlling video contents which control image quality from the video contents,

a second step of the video distribution device to distribute the image quality controlling video contents in response to a request from the contents reproduction device, and

a third step of the image quality control device to receive the image quality controlling video contents from the video distribution device and control image quality according to a mode of use.

According to a fourth exemplary aspect of the invention, an image quality controlling contents generation program of an image quality controlling contents generation device which generates image quality controlling contents from video contents, which is executed on a computer to cause the computer to execute

a scalable coding processing of hierarchically coding the video contents to generate image quality controlling video contents, and

a scalable coding parameter generation processing of generating a coding parameter for controlling a hierarchical structure for use in executing scalable coding in the scalable coding processing.

According to a fifth exemplary aspect of the invention, an image quality control program of an image quality control device connected through a network to a video distribution device which distributes image quality controlling video contents generated by an image quality controlling video contents generation device in response to a request, which is executed on a computer to cause the computer to execute

a contents reception processing of receiving the image quality controlling video contents,

a quality control parameter generation processing of generating an image quality control parameter for controlling image quality of the video signal according to a mode of use of the image quality controlling video contents,

a quality control processing of controlling image quality of a video signal to be output based on image quality controlling video contents received in the contents reception processing and the image quality control parameter generated in the quality control parameter generation processing, and

a contents output processing of selectively outputting at least one of transfer of the image quality controlling video contents to other contents reproduction device, reproduction of the image quality controlling video contents and recording of the image quality controlling video contents according to the mode of use.

According to the present invention, it is possible to provide an image quality controlling contents generation device, an image quality control device, a copy image quality control system, a copy image quality control method, an image quality controlling contents generation program and an image quality control program which prevent reproduction of contents with higher image quality than intended by a contents designer by setting up a mechanism of transmitting only contents of a necessary layer to realize control of reproduction quality.

The reason is that by not copying a part of layers at the time of copying hierarchically coded video contents, contents as of after copying will be deteriorated, so that even when the copied contents are decoded and copied by a malicious user, copying with the same image quality of contents as that of an original is impossible.

### BRIEF DESCRIPTION OF THE DRAWINGS

FIG. 1 is a diagram showing a system structure of a copy image quality control system according to a first exemplary embodiment of the present invention;

FIG. 2 is a block diagram showing a structure of an image quality controlling contents generation device according to the first exemplary embodiment of the present invention;

FIG. 3 is a block diagram showing a structure of an image quality control device according to the first exemplary embodiment of the present invention;

FIG. 4 is a flow chart showing operation of the image quality controlling contents generation device according to the first exemplary embodiment of the present invention;

FIG. 5 is a flow chart showing operation of the image quality control device according to the first exemplary embodiment of the present invention;

FIG. 6 is a diagram for use in explaining scalable coding by the image quality controlling contents generation device according to the first exemplary embodiment of the present invention;

FIG. 7 is a diagram for use in explaining layer deletion operation of the image quality control device according to the first exemplary embodiment of the present invention;

FIG. 8 is a diagram for use in explaining layer setting operation of the copy image quality control system according to the first exemplary embodiment of the present invention; and

FIG. 9 is a block diagram showing a structure of an example of modification of the image quality control device according to the first exemplary embodiment of the present invention.

### EXEMPLARY EMBODIMENT

Next, exemplary embodiments of the present invention will be described in detail with reference to the drawings.

### Structure of First Exemplary Embodiment

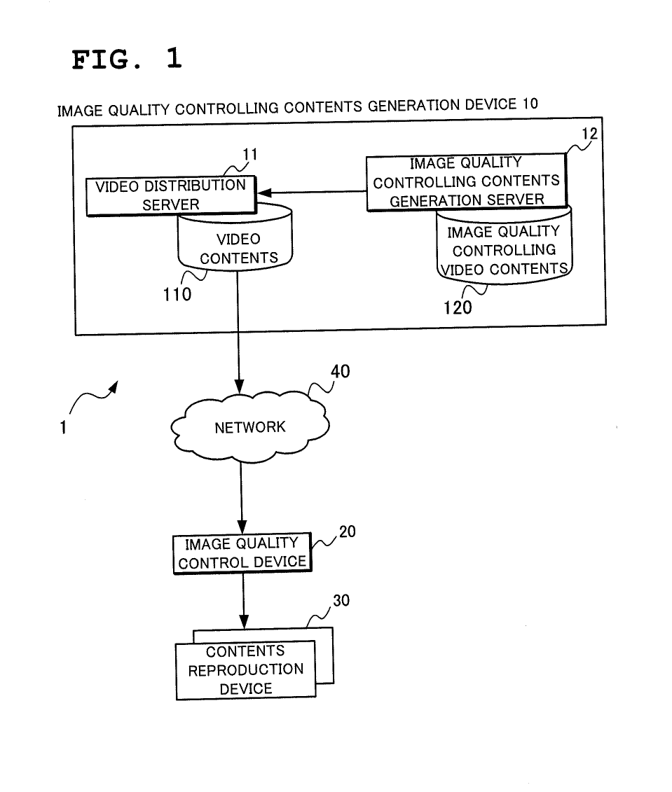

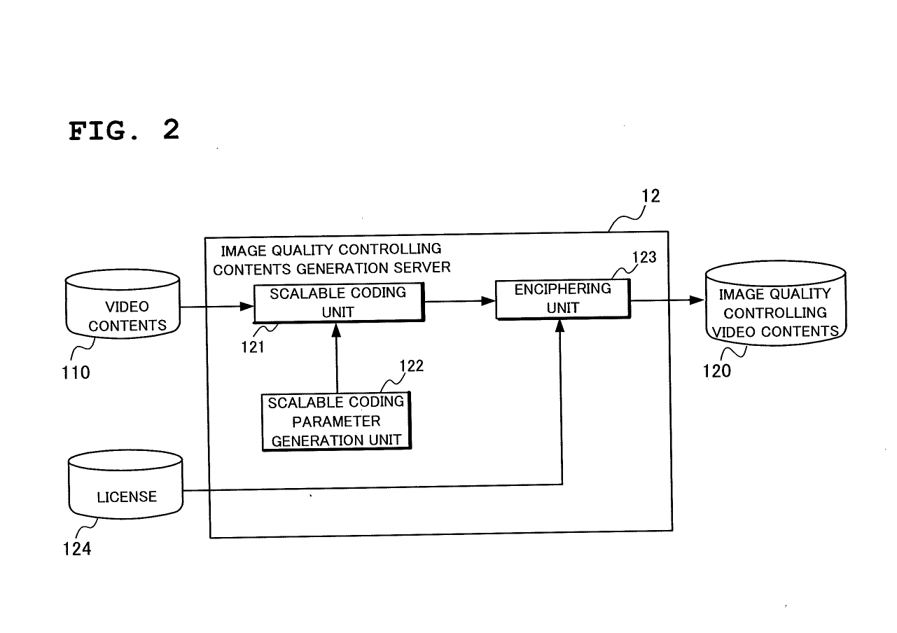

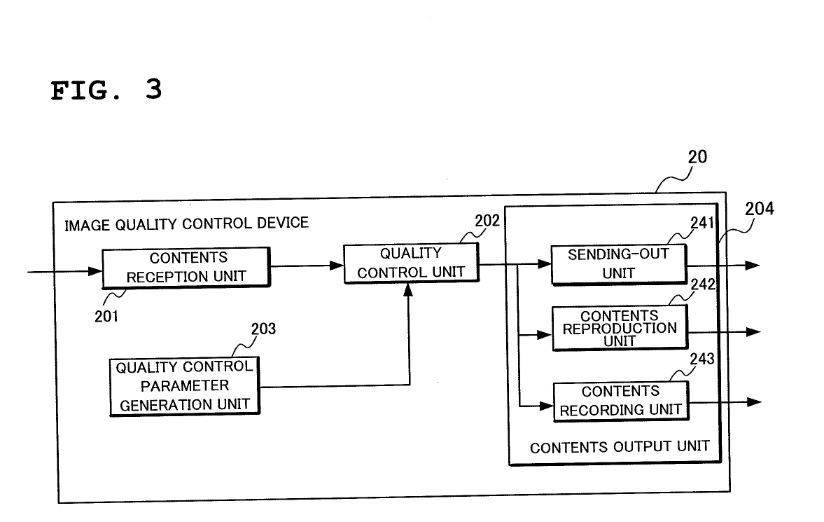

FIG. 1 is a diagram showing a system structure of a copy image quality control system according to a first exemplary embodiment of the present invention, FIG. 2 is a block diagram showing a structure of an image quality controlling contents generation device according to the first exemplary embodiment of the present invention and FIG. 3 is a block diagram showing a structure of an image quality control device according to the first exemplary embodiment of the present invention.

With reference to FIG. 1, a copy image quality control system 1 according to the present exemplary embodiment includes a video distribution server 11 and an image quality controlling contents generation server 12 which form an image quality controlling contents generation device 10, and an image quality control device 20 connected to the image quality controlling contents generation device 10 through a network 40. To the image quality control device 20, a contents reproduction device 30 is connected.

The image quality controlling contents server 12 generates image quality controlling video contents whose image quality is controllable at the time of copying from video contents stored in a video contents DB (Data Base) 110. The video distribution server 11 distributes image quality controlling video contents generated by the image quality controlling contents server 12 in response to a request from the image quality control device 20 or the contents reproduction device 30. The image quality control device 20 receives image quality controlling video contents 120 from the video distribution server 11 through the network 40 and controls the image quality according to a mode of use to obtain a reproduced image by the contents reproduction device 3.

With reference to FIG. 2, the image quality controlling contents generation server 12 forming the image quality controlling contents generation device 10 includes a scalable coding unit 121, a scalable coding parameter generation unit 122 and an enciphering unit 123. The image quality controlling contents generation device 10 manages the video contents DB 110, the image quality controlling contents DB 120 and a license key DB 124.

The scalable coding unit 121 hierarchically codes video contents stored in the video contents DB 110 to generate the image quality controlling video contents 120 and outputs the same to the enciphering unit 123 as will be described later. The scalable coding parameter generation unit 122 generates a coding parameter which controls a hierarchical structure for use in scalable-coding by the scalable coding unit 121 and outputs the same to the scalable coding unit 121. The enciphering unit 123 enciphers the image quality controlling video contents output by the scalable coding unit 121 by using a license key stored in the license DB 124 and outputs the obtained contents to the image quality controlling video contents DB 120. Coding parameter which controls a hierarchical structure represents information indicating whether a specific layer such as a higher layer should be deleted or not.

With reference to FIG. 3, the image quality control device 20 includes a contents reception unit 201, a quality control unit 202, a quality control parameter generation unit 203 and a contents output unit 204. The contents output unit 204 further includes a sending-out unit 241, a contents reproduction unit 242 and a contents recording unit 243.

The contents reception unit 201 receives image quality controlling video contents from the video distribution server 11 and outputs the same to the quality control unit 202. To the quality control unit 202, further input is a parameter for controlling image quality from the quality control parameter generation unit 203 according to use of the image quality controlling video contents. Parameter here includes information related to a layer to be deleted. The quality control unit 202 controls image quality to be output based on the image quality controlling video contents output from the contents reception unit 201 and the image quality control parameter obtained from the quality control parameter generation unit 203 to output the same to the contents output unit 204.

The contents output unit 204 selectively outputs one or a combination of transfer of the image quality controlling video contents to other contents reproduction device 30, reproduction of image quality controlling video contents and recording of image quality controlling video contents according to a mode of use. Therefore, the sending-out unit 241 transfers image quality controlling video contents 21 to other contents reproduction device 30, the contents reproduction unit 242 reproduces image quality controlling video contents and the contents recording unit 243 records the image quality controlling video contents at a recording medium.

### Operation of Copy Image Quality Control System of First Exemplary Embodiment

With the above-described structure, for executing image quality control at the time of copying, the image quality controlling contents generation server 12 generates image quality controlling video contents from video contents. The image quality controlling video contents are generated by scalable-coding by the scalable coding unit 121 of the image quality controlling contents generation server 12. Assume that executed here is scalable-coding formed of a base layer and an extension layer according to H.264/SVC which will be described later.

Scalable coding has a coding form in which video contents are layered and is characterized in that among a plurality of layers, contents including only lower layers have an image of a low image quality and they will have an image of a higher image quality step by step as a higher layer is added. Scalable hierarchical structure is controlled by a parameter generated by the scalable coding parameter generation unit 122 of the image quality controlling contents generation server 12.

The image quality controlling video contents 120 generated by the image quality controlling contents generation server 12 are distributed according to a request from the video distribution server 11. The distributed image quality controlling video contents 120 are received by the image quality control device 40 through the network 40 and the image quality control device 20 controls image quality at the time of use by deleting higher layers of contents according to a mode of use.

The image quality control device 20 receives the image quality controlling video contents distributed from the video distribution server 11 by the contents reception unit 201. The quality control unit 202 controls image quality by deleting or not deleting a higher layer of image quality controlling video contents received according to a mode of use. Parameter indicating which layer is to be deleted or not to be deleted is generated by the quality control parameter generation unit 203. The layer control depends on a mode of use of the image quality controlling video contents and is selected by the contents output unit 204 under the control of the quality control unit 203.

The contents output unit 204 comprises the sending-out unit 241 which transfers contents to other contents reproduction device without modification, the contents reproduction unit 242 which reproduces video contents and uses the same and the contents recording unit 243 which records contents on a recording medium, and has its image quality controlled by the quality control unit 202 and has its video contents used according to a mode of use. Controlling image quality by the quality control unit 202 prevents inappropriate use of video whose image quality is the same as that of an original.

### Effects of Copy Image Quality Control System of the First Exemplary Embodiment

With the above-described copy image quality control system 1 according to the first exemplary embodiment of the present invention, refraining from copying a part of layers at the time of copying hierarchically-coded video contents will have contents whose image quality is deteriorated after copying, which results in controlling quality as of after copying.

The reason is that while video contents themselves are decodable and can be viewed and listened, refraining from copying a part of layers enables image quality to be deteriorated.

Even if contents as of after copying are copied by decoding encryption by a malicious user, they cannot be copied to have the image quality of the original contents. The reason is that contents as of after copying have a part of layers deleted and therefore have their image quality deteriorated without fail.

### Operation of Image Quality Controlling Contents Generation Device of the First Exemplary Embodiment

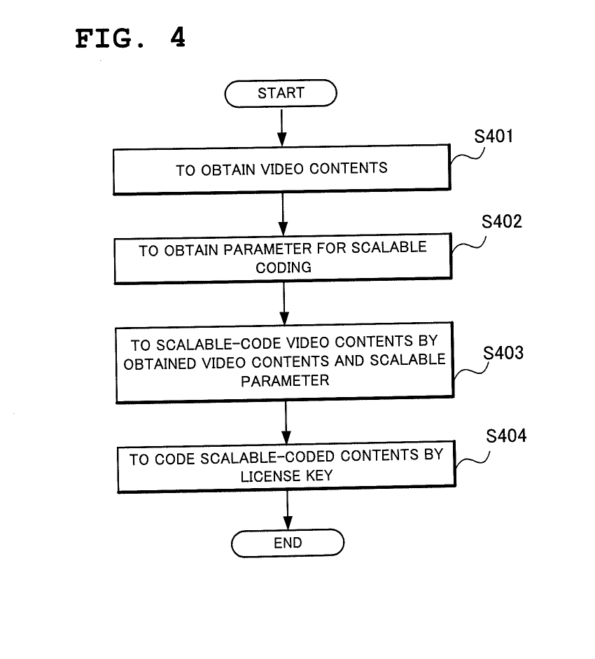

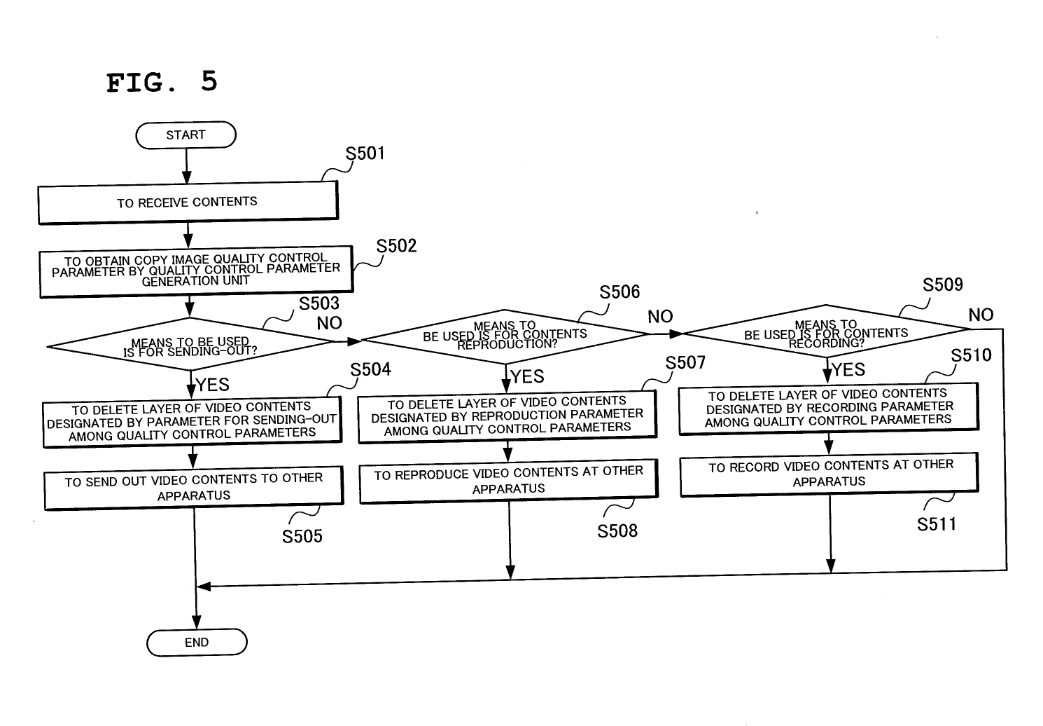

Next, detailed description will be made of operation of the image quality controlling contents generation device 10 and the image quality reproduction device 20 according to the present exemplary embodiment with reference to the flow charts shown in FIG. 4 and FIG. 5.

First, description will be made of operation of the image quality controlling contents generation device 10. With reference to FIG. 4, the image quality controlling contents generation server 12 forming the image quality controlling contents generation device 10 converts the video contents 110 into a form in which image quality as of after copying can be controlled. More specifically, the scalable coding unit 121 obtains target video contents from the video contents DB 110 (Step S401). Next, the scalable coding parameter generation unit 122 generates a coding parameter which describes a layer to be deleted at the time of scalable coding and the scalable coding unit 121 obtains the same (Step S402).

As a result, the scalable coding unit 121 codes the video contents 20 based on the coding parameter (Step S403). At this time, when the coding parameter generated by the scalable coding parameter generation unit 122 has a description to the effect that a higher layer is to be deleted, the video contents scalable-coded here includes no higher layer. Next, the video contents coded by the scalable coding unit 121 are enciphered by the enciphering unit 123 by using a license key held in the license DB 124 (Step S404). Scalable-coding the video contents 20 and enciphering the same by the foregoing-described operation will complete image quality controlling video contents.

### Effects of the Image Quality Controlling Contents Generation Device of the First Exemplary Embodiment

As described in the foregoing, according to the image quality controlling contents generation device of the first exemplary embodiment, controlling a parameter generated by the scalable coding parameter generation unit 122 enables an image quality of copied video contents to be controlled, so that only video contents of a necessary layer will be distributed to the contents reproduction device 30. Therefore, contents reproduction is impossible whose quality is higher than intended by a contents designer.

The reason is that while video contents themselves are decodable and video viewing and listening are possible, image quality can be deteriorated by refraining from copying a part of layers. Moreover, even if contents are copied after decoding encryption by a malicious user, the copied contents have a part of their layers deleted and therefore have image quality deteriorated without fail, so that copying with the same image quality as that of the original contents is impossible.

### Operation of Image Quality Control Device of the First Exemplary Embodiment

As described above, the image quality controlling video contents generated by the image quality controlling contents generation server 12 are distributed by the video distribution server 11. By issuing a distribution request to the contents distribution server 11 by the image quality control device 20 or the contents reproduction device 30, distribution of image quality controlling contents by the video distribution server 11 is started. The image quality control device 20 receives image quality controlling video contents from the video distribution server 11 and controls image quality according to a mode of use of the contents reproduction device 30. In the following, operation of the image quality control device 20 will be described with reference to the flow chart shown in FIG. 5.

With reference to FIG. 5, the image quality control device 20 first receives image quality controlling video contents distributed from the video distribution server 11 at the contents reception unit 201 (Step S501). At this time, the quality control parameter generation unit 203 generates a quality control parameter indicating how video quality is controlled and transfers the same to the quality control unit 202 (Step 502). Quality control parameter here differs with a mode of use of the contents reproduction device 30. More specifically, a quality control parameter is, in a case of contents sending, used as a contents sending-out parameter, in a case of contents reproduction, used as a contents reproduction parameter and in a case of contents recording, used as a contents recording parameter, in any case of which, a layer to be deleted is designated.

The image quality control device 20, when video contents are simply transferred to the contents reproduction device 30 (“Yes” at Step S503), deletes a layer of the video contents designated by the contents sending-out parameter generated by the quality control parameter generation unit 203 (Step S504) and transfers the video to the contents reproduction device 30 (Step S505).

When the contents reproduction device 30 reproduces video contents (“Yes” at Step S506), delete a layer of video contents designated by the contents reproduction parameter generated at the quality control parameter generation unit 230 (Step S507) and reproduce video at the contents reproduction device 30 (Step S508).

When recording the received video contents (“Yes” at Step S509), delete a layer of video contents designated by the recording parameter generated at the quality control parameter generation unit 203 (Step S510) and record the video at the contents reproduction device 30 (S511).

### Effects of Image Quality Control Device of the First Exemplary Embodiment

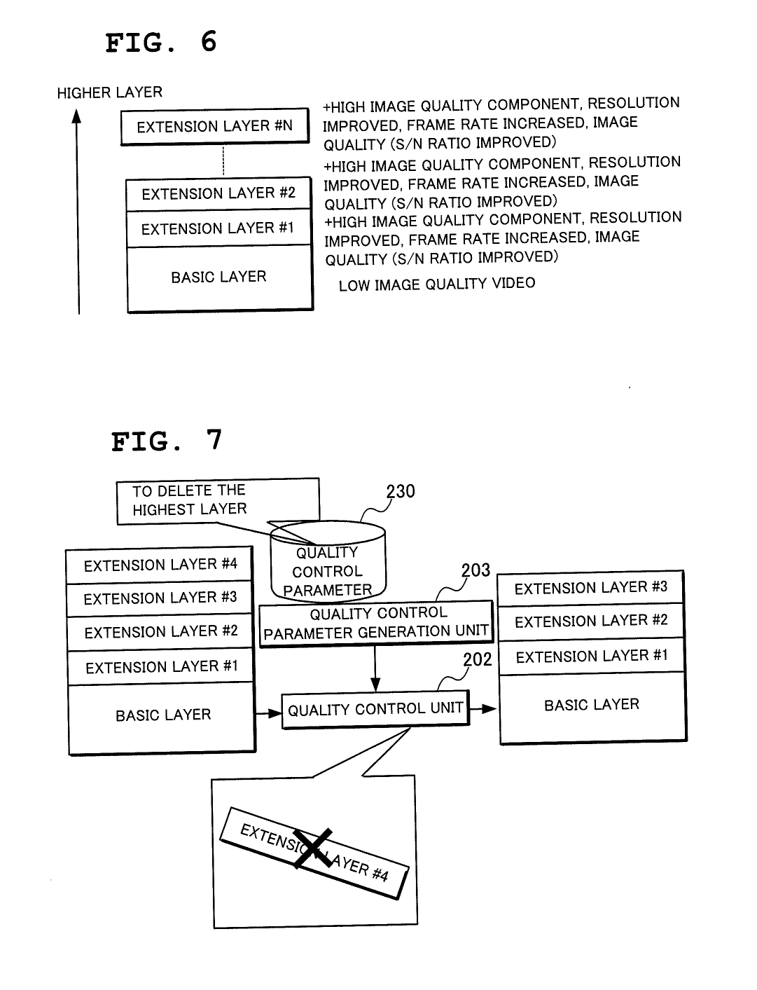

According to the above-described image quality control device of the present exemplary embodiment, image quality of copied video contents can be controlled by controlling a quality control parameter generated at the quality control parameter generation unit 203. Image quality controlling video contents are hierarchically coded by scalable coding. Scalable coding is, for example, as shown in FIG. 6, formed of a plurality of layers, in which low image quality video coded as a basic layer will have a high image quality by the addition of codes of higher layers #1 through #N. Even without a higher layer code at the time of decoding, video of a layer in question can be decoded as long as lower layers all exist.

In a case, for example, where the quality control parameter generation unit 203 of the image quality control device 20 describes a quality control parameter as a sending-out parameter assuming that video is to be sent out excluding the highest layer of scalable coding, copying to have the same quality as that of an original of the copied video contents can be inhibited, for example, as shown in FIG. 7, deletion of an image of a layer designated by the processing at Step S504 of FIG. 5 by the image quality control device 20 makes an image quality of video contents transferred be lower than that of its original.

### Application Example of the First Exemplary Embodiment

According to the above-described copy image quality control system 1 of the first exemplary embodiment, although the description has been made assuming that a coding parameter and a quality control parameter are generated by the scalable coding parameter generation unit 121 or the quality control parameter generation unit 203, they can be manually set by a service provider or a contents provider which distributes video contents. For example, the scalable coding parameter generation unit 121 may externally designate the number of scalable layers to be coded or parameters related to layers. In scalable coding, for example, resolution of each layer, a frame rate and an image quality (S/N) can be changed. Parameters related to these layers can be freely set by a form of service supplied by a service provider.

When considering only HD (High Definition) video as target contents in video contents distribution, it is possible to set to change only an image quality (S/N) without changing a resolution from HD in each layer. On this occasion, when deleting layers starting with the highest one, image quality will be gradually deteriorated with the resolution remaining HD. On the other hand, at the setting of lowering the resolution with the highest layer remaining HD video, deleting layers starting with the highest one will have a small screen at the time of reproduction.

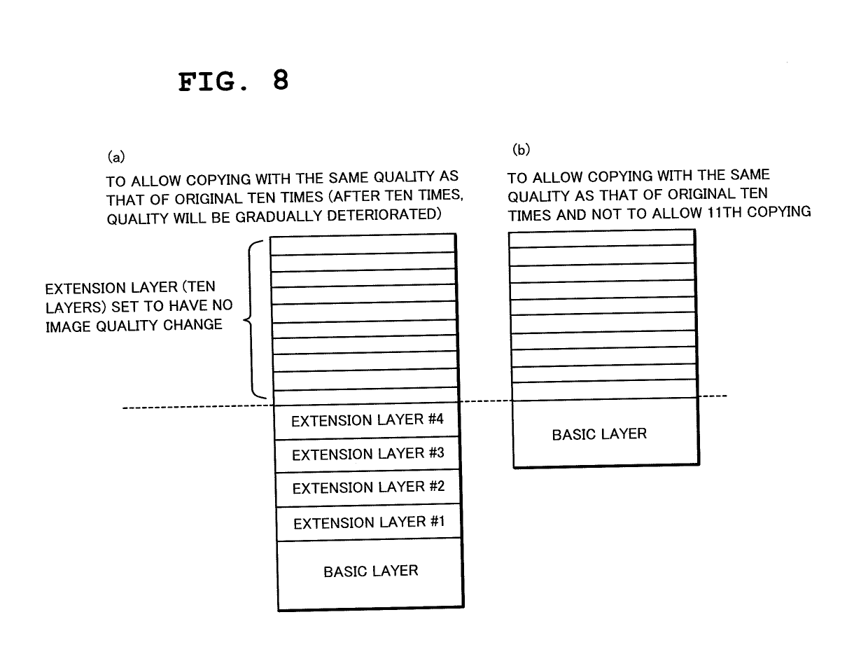

Further possible is to allow copying to have the same image quality as that of an original at initial several times and then gradually deteriorate video. Shown in FIG. 8(a) is an example where copying is allowed ten times. In FIG. 8(a), highest ten layers are dummy layers which cause no change in image quality and therefore deletion of higher layers will change no image quality. While up to ten-time copying, only a dummy higher layer is deleted, deletion of more than ten layers will have image quality deteriorating gradually. This arrangement allows initial ten times to have copying with the same image quality as that of the original.

FIG. 8(b) shows an example where highest ten layers are dummy layers which cause no image quality change and the remainder is only the lowest basic layer. With the layers formed in such a manner, copying with same image quality as that of an original is allowed ten times but no copying is allowed at the eleventh time and so on because the basic layer is deleted at the eleventh time.

While the image quality controlling contents generation device 10 according to the present exemplary embodiment is premised on the use of H.264/SVC standardized by ITU-T as scalable coding, it is not limited to this system and other coding system is also applicable.

In addition, the quality control parameter generation unit 203 may obtain a fixed parameter for deleting the highest layer one by one at the image quality control device 20 without fail or may obtain a parameter fixed by a service provider. For obtaining a parameter here, at the same time of acquisition of contents from the video distribution server 11 through the network 40, a quality control parameter may be received. It is also possible to set a quality control parameter by a separate physical means such as a license card. When obtaining a quality control parameter from a service provider, it is possible not to use a fixed parameter but to change a control level according to video contents.

Such flexible layer control is possible as strictly controlling quality of popular contents to delete the highest two layers or delete all the layers, while loosely controlling quality of contents which are not accessed so often to delete only one higher layer. On this occasion, when transferring contents to other contents reproduction device through the sending-out unit 241 of the contents output unit 204 or recording contents at the contents recording unit 243, a quality control parameter may be transferred or recorded together with the contents.

The quality control parameter, which is described to change control contents according to a purpose of use, realizes video viewing and listening with high image quality by deleting a higher layer to deteriorate quality when transferring the contents to other contents reproduction device or recording the same, and by refraining from deleting a higher layer when simply reproducing the contents. The quality control parameter is not limitedly used for these purposes but can be set with control contents changed.

The image quality control device 20 need not always comprise all of the sending-out unit 241, the contents reproduction unit 242 and the contents recording unit 243 according to a purpose of use. The device, for example, may comprise only the sending-out unit 241, and may execute only transfer to other contents reproduction device, or may execute only contents reproduction and recording without comprising the sending-out unit 241.

Image quality controlling contents to be distributed by the above-described image quality control device 20 according to the present exemplary embodiment are enciphered by the enciphering unit 123 of the image quality controlling contents generation server 12. Some service, however, requires no encryption and in this case, the image quality controlling contents generation server 12 fails to have the enciphering unit 123 and some of the image quality controlling video contents are yet to be enciphered in some cases.

With the structure of the image quality control device 20 shown in FIG. 3, when encryption is required, no cipher of enciphered image quality controlling video contents is decoded and a scalable coding layer is deleted by the quality control unit 202. It is desirable to encipher contents of video contents but not layer information indicating which layer is included in the contents at the enciphering unit 123 of the image quality controlling contents generation server 12, while deleting and selecting a layer without decoding ciphers by the quality control unit 202 of the image quality control device 20.

For example, while contents of video contents are enciphered, it is also possible, with layer information described in a header part of video contents or at a starting part of a layer or a header part of a packet in which video is sent, to delete and select a layer by the quality control unit 202 based on layer information described in the header.

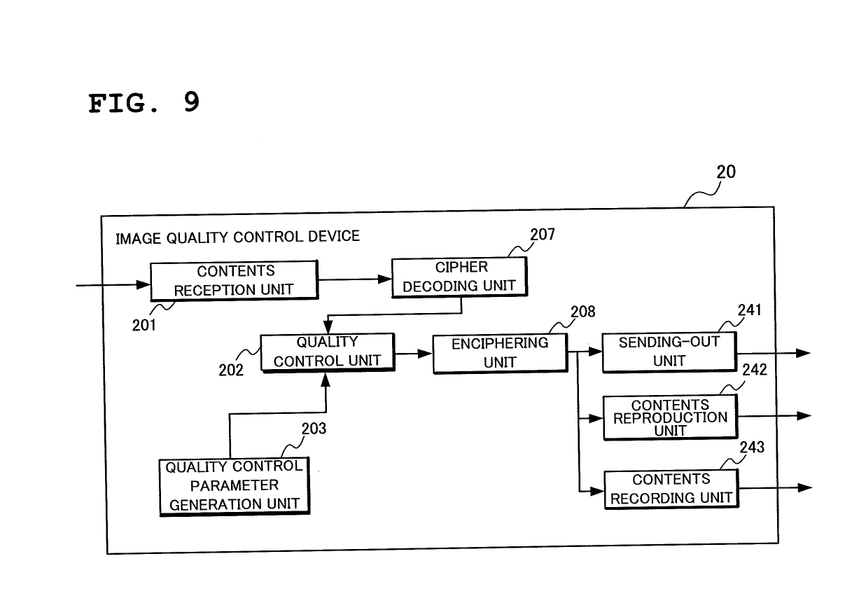

For enciphering layer information, however, the image quality control device 20 requires such a structure as shown in FIG. 9, for example. More specifically, it is structured to decode ciphers by using a license key at a cipher decoding unit 207 added preceding the quality control unit 202. On this occasion, for obtaining a license key, the license key is received as well when obtaining contents from the video distribution server through the network 40. License key may be obtained by other physical means such as a license card. In this case, an enciphering unit 208 connected succeeding the quality control unit 202 may execute encryption by using a license key.

The functions that the image quality controlling contents generation server 12 shown in FIG. 2 may be all realized in software or at least a part of them may be realized in hardware. For example, data processing executed by the scalable coding unit 121 to hierarchically code video contents and generate image quality controlling video contents or data processing executed by the scalable coding parameter generation unit 122 to generate a coding parameter which controls a hierarchical structure when scalable coding is executed by the scalable coding unit 121 may be realized on a computer by one or a plurality of programs or at least part of the processing may be realized in hardware.

The functions that the image quality control device 20 shown in FIG. 3 may be realized all in software or at least a part of them may be realized in hardware. Data processing executed by the quality control parameter generation unit 203 to generate an image quality control parameter which controls image quality of a video signal according to a mode of use of image quality controlling video contents, data processing executed by the quality control unit 202 to control image quality of a video signal to be output based on image quality controlling video contents received at the contents reception unit 201 and an image quality control parameter generated at the quality control parameter generation unit 203 or data processing executed by the contents output unit 204 to selectively output at least one of transfer of image quality controlling video contents to other contents reproduction device, reproduction of image quality controlling video contents and recording of image quality controlling video contents according to a mode of use, may be realized on a computer by one or a plurality of programs or at least part of the processing may be realized in hardware.

Although the present invention has been described with respect to the preferred modes of implementation and exemplary embodiments in the foregoing, the present invention is not necessarily limited to the above-described modes of implementation and exemplary embodiments but can be modified without departing from the scope of its technical idea.

### INCORPORATION BY REFERENCE

This application is based upon and claims the benefit of priority from Japanese patent application No. 2009-075688, filed on Mar. 26, 2009, the disclosure of which is incorporated herein in its entirety by reference.

1. An image quality controlling contents generation device which generates image quality controlling contents from video contents, comprising:
a scalable coding unit which hierarchically codes said video contents to generate image quality controlling video contents; and
a scalable coding parameter generation unit which generates a coding parameter for controlling a hierarchical structure for use in executing scalable coding at said scalable coding unit.

2. The image quality controlling contents generation device according to claim 1, further comprising an enciphering unit which enciphers, by using a license key, said image quality controlling video contents coded at said scalable coding unit.

3. The image quality controlling contents generation device according to claim 1, wherein said scalable coding parameter generation unit generates said coding parameter for controlling a hierarchical structure based on manually input information.

4. An image quality control device connected through a network to a video distribution device which distributes image quality controlling video contents generated by an image quality controlling video contents generation device in response to a request, comprising:
a contents reception unit which receives said image quality controlling video contents;
a quality control parameter generation unit which generates an image quality control parameter for controlling image quality of said video signal according to a mode of use of said image quality controlling video contents;
a quality control unit which controls image quality of a video signal to be output based on image quality controlling video contents received at said contents reception unit and the image quality control parameter generated at said quality control parameter generation unit; and
a contents output unit which selectively outputs at least one of transfer of said image quality controlling video contents to other contents reproduction device, reproduction of said image quality controlling video contents and recording of said image quality controlling video contents according to said mode of use.

5. The image quality control device according to claim 4, wherein said quality control parameter generation unit generates said image quality controlling parameter for controlling a hierarchical structure based on manually input information.

6. The image quality control device according to claim 4 or claim 5, further comprising a cipher decoding unit which decodes said image quality controlling video contents received by said contents reception unit.

7. The image quality control device according to claim 6, further comprising an enciphering unit which enciphers said image quality controlling video contents whose image quality is controlled by said quality control unit.

8. A copy image quality control system, comprising:
an image quality controlling contents generation device which generates image quality controlling video contents which control image quality from video contents;
a video distribution device which distributes said image quality controlling video contents in response to a request; and
an image quality control device connected to said video distribution device through a network to receive said image quality controlling video contents from said video distribution device and control image quality according to a mode of use.

9. A copy image quality control method for use in a copy image quality control system to which connected through a network are a video distribution device which distributes image quality controlling video contents generated by an image quality controlling video contents generation device in response to a request and an image quality control device to which a contents reproduction device is connected, comprising:
a first step of said image quality controlling contents generation device to generate image quality controlling video contents which control image quality from said video contents;
a second step of said video distribution device to distribute said image quality controlling video contents in response to a request from said contents reproduction device; and
a third step of said image quality control device to receive said image quality controlling video contents from said video distribution device and control image quality according to a mode of use.

10. The copy image quality control method according to claim 9, wherein said first step includes
a scalable coding step of hierarchically coding said video contents to generate image quality controlling video contents, and
a scalable coding parameter generating step of generating a coding parameter for controlling a hierarchical structure for use in executing said scalable coding.

11. The copy image quality control method according to claim 9, wherein said first step includes an enciphering step of enciphering image quality controlling video contents generated at said scalable coding step by using a license key.

12. The copy image quality control method according to claim 10, wherein said scalable coding parameter generation step includes generation of said coding parameter based on manually input information.

13. The copy image quality control method according to claim 9, wherein said third step includes
a contents reception step of receiving said image quality controlling video contents,
a quality control parameter generation step of generating an image quality control parameter for controlling image quality of said video signal according to a mode of use of said image quality controlling video contents,
a quality control step of controlling image quality of a video signal to be output based on image quality controlling video contents received at said contents reception step and the image quality control parameter generated at said quality control parameter generation step, and
a contents output step of selectively outputting at least one of transfer of said image quality controlling video contents to other contents reproduction device, reproduction of said image quality controlling video contents and recording of said image quality controlling video contents according to said mode of use.

14. The copy image quality control method according to claim 13, wherein said quality control parameter generation step includes generation of said image quality controlling parameter based on manually input information.

15. The copy image quality control method according to claim 13, further comprising a cipher decoding step of decoding said image quality controlling video contents received at said contents reception step.

16. The copy image quality control method according to any one of claim 13, further comprising an enciphering step of enciphering said image quality controlling video contents whose image quality is controlled by said quality control unit.

17. A computer-readable medium storing an image quality controlling contents generation program of an image quality controlling contents generation device which generates image quality controlling contents from video contents, wherein said image quality controlling contents generation program is executed on a computer to cause said computer to execute
a scalable coding processing of hierarchically coding said video contents to generate image quality controlling video contents, and
a scalable coding parameter generation processing of generating a coding parameter for controlling a hierarchical structure for use in executing scalable coding in said scalable coding processing.

18. The computer-readable medium according to claim 17, wherein said image quality controlling contents generation program causes said computer to execute an enciphering processing of enciphering image quality controlling video contents generated in said scalable coding processing by using a license key.

19. The computer-readable medium according to claim 17, wherein said scalable coding parameter generation processing includes generation of said coding parameter based on manually input information.

20. A computer-readable medium storing an image quality control program of an image quality control device connected through a network to a video distribution device which distributes image quality controlling video contents generated by an image quality controlling video contents generation device in response to a request, wherein said image quality controlling contents generation program is executed on a computer to cause said computer to execute
a contents reception processing of receiving said image quality controlling video contents,
a quality control parameter generation processing of generating an image quality control parameter for controlling image quality of said video signal according to a mode of use of said image quality controlling video contents,
a quality control processing of controlling image quality of a video signal to be output based on image quality controlling video contents received in said contents reception processing and the image quality control parameter generated in said quality control parameter generation processing, and
a contents output processing of selectively outputting at least one of transfer of said image quality controlling video contents to other contents reproduction device, reproduction of said image quality controlling video contents and recording of said image quality controlling video contents according to said mode of use.

21. The computer-readable medium according to claim 20, wherein said quality control parameter generation processing includes generation of said image quality controlling parameter based on manually input information.

22. The computer-readable medium according to claim 20, wherein said image quality controlling contents generation program causes said computer to execute a cipher decoding processing of decoding said image quality controlling video contents received in said contents reception processing.

23. The computer-readable medium according to claim 20, wherein said image quality controlling contents generation program causes said computer to execute an enciphering processing of enciphering said image quality controlling video contents whose image quality is controlled in said quality control processing.
